(19) United States
(12) Patent Application Publication
(10) Pub. No.: US 2006/0106646 A1
(43) Pub. Date: May 18, 2006

(54) Medical kiosk with multiple input sources

(75) Inventors: John R. Squilla, Rochester, NY (US); Philip R. Ashe, Rochester, NY (US); Kim W. Montz, Webster, NY (US); Donna K. Rankin-Parobek, Honeoye Falls, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/991,553

(22) Filed: Nov. 18, 2004

(51) Int. Cl. G06F 19/00; G06K 5/00

(52) U.S. Cl. 705/3; 235/380

(57) ABSTRACT

A method of creating or updating a personal information device includes entering patient identification information, medical history information, current patient care plan, and patient medical preference information onto a computer (88). The patient identification information, medical history information, current patient care plan, and patient medical preference information is written or updated on the personal information device.

### FIELD OF THE INVENTION

This invention applies to the fields of medical testing, medical kiosks, and electronic patient records, and in particular, to the use of electronic patient records in conjunction with a medical kiosk.

### BACKGROUND OF THE INVENTION

It is well known that patient medical records exist, and that electronic representations of these records are stored today. These medical records can be stored in multiple embodiments such as on a medical card, a computerized database system, or even dog tags on soldiers. U.S. Patent Application Publication No. 2004/0204961 (Rensimer et al.) discusses a system and method for processing patient data that permits physicians and other medical staff personnel to record historical patient care information. This patent publication teaches that the medical care data can be recorded, saved, and transferred from a portable system to a larger stationary information or database system.

The methods of generating a medical record into electronic format are well known. A doctor, nurse, medical assistant, or clerical assistant can enter patient data into a computer via a manual computer keyboard, voice recognition system, or by scanning existing documents via a scanning system. Once the data is loaded on the computer, an electronic patient record (EPR) can be generated via a card writer (the card can be embodied in a credit card-type option, a CD, DVD, or any form of physical storage media that exists in the marketplace), or by an electronic connection (wired or wireless) to another computer, a personal digital assistant (PDA), cellular phone, or via the Internet for remote storage and future use. U.S. Patent Application Publication No. 2003/0177033 (Park et al.) teaches a method of transmitting an EPR between doctors and pharmacies for prescription and treatment information, using the Internet. The iMetrikus MediCompass system (www.iMetrikus.com) provides the ability for patients to electronically monitor chronic conditions, record test results and communicate on-line with their physicians.

Non-medical kiosks such as automated teller machines (ATMs) require user authentication in order to access personal records prior to performing a transaction. This authentication can take the form of submitting a bankcard and pin number, a user id and password, or more sophisticated biometric analysis. Known biometric authentication means include voiceprints, finger or thumbprints, DNA testing and retinal scanning. U.S. Pat. No. 6,758,394 (Maskatiya et al.) teaches a method for verifying a user's identity and authorizing transactions with a self-service device using biometric identification means. U.S. Patent Application Publication No. 2001/0044777 (Haley et al.) teaches the art of authorizing and approving a transaction via a mobile device.

There exist unassisted medical kiosks in the marketplace that provide basic vital statistics monitoring such as patient heart rate and blood pressure (see LifeClinic at www.LifeClinic.com). U.S. Patent Application Publication No. 2004/0044560 (Giglio et al.) discusses a device to test and output the personal data (fat analysis) of a user to a computer processor. U.S. Pat. No. 6,692,436 (Bluth et al.) teaches a health kiosk that provides blood pressure testing, a health and fitness evaluation and a medication encyclopedia. Other unassisted kiosks aid a user in diagnosing a condition by using question and answer scripts to reach a diagnostic conclusion. U.S. Pat. No. 6,641,532 (Iliff) teaches the art of conducting an automated diagnostic session with a patient, using a plurality of disease scripts, a patient medical record, and a disease engine to process the script and route the changes to the medical record. Staffed medical kiosks also exist that provide a nurse to check on certain ailments (see MinuteClinic at www.MinuteClinic.com).

All of these medical kiosks provide convenient medical services to consumers with improved accessibility over visits to a doctor's office. However, the unassisted kiosks are limited in their ability to provide comprehensive diagnostic services due to the lack of secure access to patient medical records (including doctor's orders, prescription information and individual patient history) and the inability to perform diagnostic tests beyond basic vital statistic analysis or question and answer scripts. Although assisted kiosks can provide more diagnostic tests for patients, they are limited in convenience by their hours of operation, limited number of locations, and limited access to electronic patient records.

A need exists in the marketplace to further extend the utility of medical kiosks to provide a greater variety of medical functions in convenient, accessible locations; while ensuring that patient privacy, and the security and integrity of electronic medical records are maintained.

The following applications have been cited that relate to the art, yet do not solve the problem stated in this application:
U.S. Patent Application Publication No. 2004/0124966 (Forrest) teaches the art of authentication of a wireless security device.
U.S. Patent Application Publication No. 2004/0044560 (Giglio et al.) teaches the art of device to test and output the personal data (fat analyzer) of a user to a computer processor.
U.S. Pat. No. 6,641,532 (Iliff) teaches the art of an automated diagnostic session with a patient, plurality of disease scripts, a patient medical record, a disease engine to process the script and route the changes to the medical record.
U.S. Pat. No. 6,438,451 (Lion) teaches the art of dispensing drugs through networked kiosks to patients.
U.S. Patent Application Publication No. 2002/0099658 (Nielson et al.) teaches the art of retrieving and displaying information via a mobile portal.
U.S. Patent Application Publication No. 2002/0099657 (Black et al.) teaches the art of configuring a self service terminal (SST) user interface dependent on detection of a mobile computing device in the vicinity of the SST.
U.S. Patent Application Publication No. 2001/0044777 (Haley et al.) teaches the art of authorizing and approving a transaction via a mobile device.
GB Patent No. 2,365,177 (Slupe et al.) teaches the art of facilitating an exchange of digital data from a portable personal device.

### SUMMARY OF THE INVENTION

The above need is met in the following invention by incorporating secure access to multiple embodiments of electronic patient records within a medical kiosk. Briefly, according to one aspect of the present invention a method of creating or updating a personal information device includes entering patient identification information, medical history information, current patient care plan, and patient medical preference information onto a computer. The patient identification information, medical history information, current patient care plan, and patient medical preference information is written or updated on the personal information device.

This invention deals with the many embodiments of an electronic patient record (EPR) and how it can be interfaced to a Medical Kiosk. In addition to medical history information, other data can be included on an EPR to aid in patient-doctor communications, make it significantly easier to monitor a chronic condition, or to assist in maintaining a healthy lifestyle. User profile data can be a part of the EPR including, but not limited to: permission levels for sharing of information with caregivers (including trusted family members), preferred locations for prescription filling, preferred method of digital authorization (to reduce forced usage by a third party as well as improve patient ease-of-use), and EPR update methodology. Additional data from the patient's physician can also be included. Examples include: information about the physicians used by the patient, new tests to be conducted, the automated flow of test information to those needing to know the results, exception reporting (the patient can decide if the test information should be forwarded to others, for non-prescript tests, for example) and patient classification by the doctor (e.g. healthy, needs to be monitored, or under care).

The method in which the many embodiments of a medical record interact with a Medical Kiosk is important for the ease-of-use and for encouraging continued kiosk usage by the patient. Different doctors may use different means to generate an EPR. The present invention demonstrates how a Medical Kiosk can access multiple embodiments of an EPR in an easy and straightforward manner that is transparent to the customer of the kiosk while retaining security and privacy of the information.

### BRIEF DESCRIPTION OF THE DRAWINGS

FIG. 1 is a schematic view of multiple embodiments of an electronic patient record (EPR) at a Medical Kiosk.

FIG. 2 is a schematic view of how a EPR medical record is created.

FIG. 3 is a schematic view of a systems diagram and potential data forms on various EPR embodiments.

FIG. 4 shows examples of an EPR and how it interfaces to a patient and a kiosk.

FIG. 5 is a flowchart of an alternate embodiment for using an EPR card at a Medical Kiosk.

FIG. 6 is a flowchart using a credit card at a Medical Kiosk.

FIG. 7 is a flowchart of an alternate embodiment using a personal computer (PC), personal digital assistant (PDA), pocket PC or cellular phone at a Medical Kiosk.

FIG. 8 is a flowchart of an alternate embodiment using a personal biometric sensor or personal biometrics at a Medical Kiosk.

FIG. 9 is a flowchart of an alternate embodiment for a kiosk that is not connected to a network or the Internet.

### DETAILED DESCRIPTION OF THE INVENTION

The present invention will be directed in particular to elements forming part of, or in cooperation more directly with, a apparatus in accordance with the present invention. It is to be understood that elements not specifically shown or described may take various forms well known to those skilled in the art.

The general method of the invention is the use of a Medical Kiosk to verify the identity of an individual, access the individual's electronic patient record (EPR), determine tests to be performed at the Medical Kiosk, perform the tests, and record the results of the tests allowing for the individuals to use different embodiments of the card.

Multiple Embodiments for Accessing an EPR at a Medical Kiosk

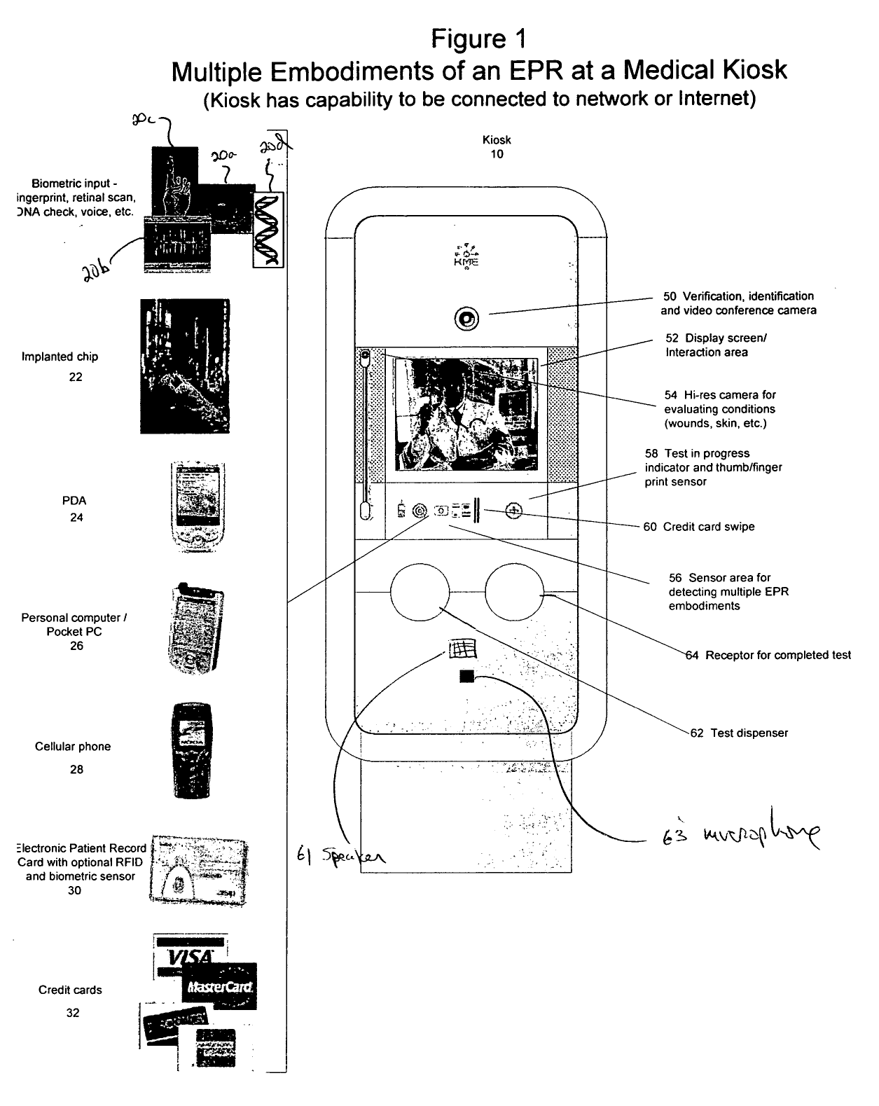

FIG. 1 illustrates the diverse set of embodiments that could be used by an individual to communicate with a Medical Kiosk 10. The Medical Kiosk 10 is designed in such a manner that an individual can choose a communication and validation method that is most convenient for their lifestyle. Specific examples of devices or embodiments are shown along the left hand side of FIG. 1. In general, these embodiments can be classified into two specific categories: biometric systems and personal information devices.

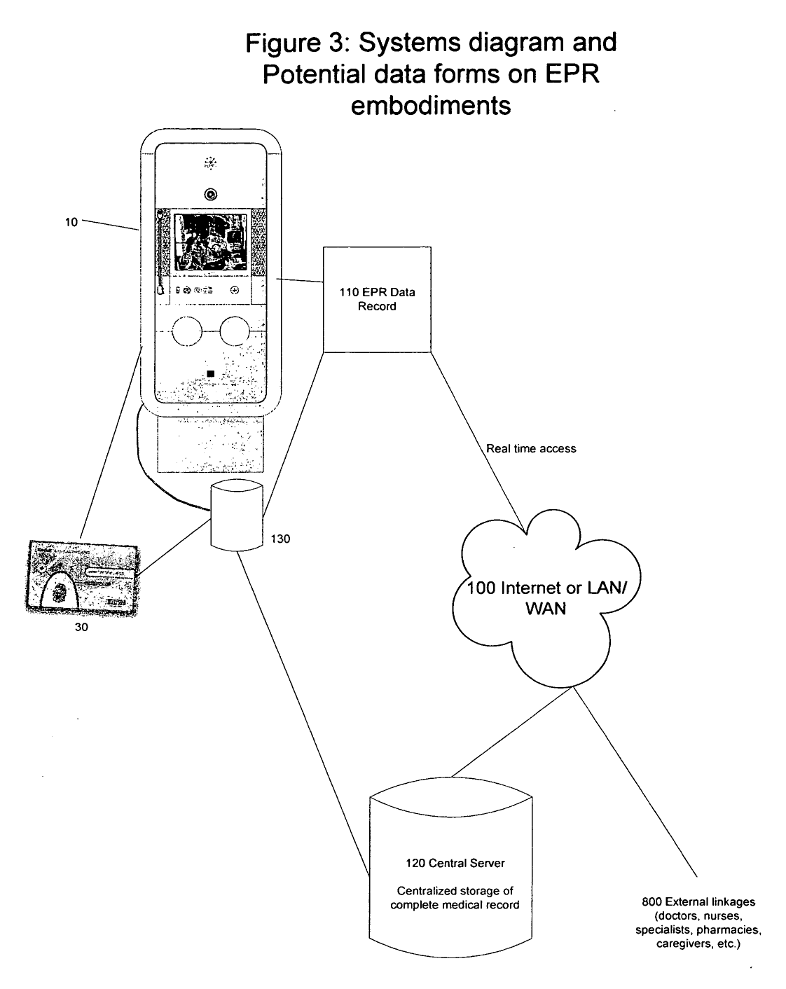

Biometric systems are used to uniquely identify the individual. For example, a retinal scan 20a of the individual is captured by a digital camera 50 and the unique retinal signature is analyzed within the image to identify the individual. In a similar manner, the Medical Kiosk 10 could use any of a number of biometrically unique features from an individual for identification purposes. Additional examples of biometric identification methods include: analysis of a voice print 20b, fingerprint matching 20c, and the analysis of an individual's unique DNA 20d (e.g. through a hair sample). Additionally, the proposed Medical Kiosk 10 can communicate with a biometric chip 22 implanted within the individual's body, in a wearable device, or as part of their clothing. Once the identification is complete, the Medical Kiosk 10 accesses the individual's EPR stored on their personal information device or, referring to FIG. 3, stored in the kiosk's local storage 130 or on a central server 120 via the internal or LAN/WAN connection 100.

Referring again to FIG. 1, the group of embodiments that are represented by personal information devices include a personal digital assistant (PDA) 24, pocket PC 26, cellular telephone 28, EPR medical card 30, credit card 32. Other devices, not shown, include a jump drive or storage card. These devices can be used to simply authenticate an individual's identity, e.g. credit card 32. Referring to FIG. 3, the Medical Kiosk 10 can then access its local storage 130 or communicate via the Internet or LAN/WAN Connection 100 with a central server 120 to access the individual's EPR. Alternately, the internal memory within these personal information devices could be used to store a wide variety of EPR information, eliminating the need to access the EPR on local storage 130 or a central server 120.

The proposed Medical Kiosk 10 would be able to seamlessly communicate with any of the above-mentioned embodiments. Examples include:

Biometric Embodiments

Individual walks up to the Medical Kiosk 10 and looks into a digital camera 50, which captures a high-resolution image of the individual's retina. The Medical Kiosk 10 would next identify unique features within the scan and compare the features to information in local storage 130, a central server 120 or encrypted information stored on a personal information device.
Individual walks up to the Medical Kiosk 10 and reads a phrase that is shown on the display screen 52. Their unique voice print 20b is identified and matched to information in local storage 130, a central server 120 or encrypted information stored on a personal information device.
Individual walks up to the Medical Kiosk 10 and provides a hair used for identification via DNA analysis. The Medical Kiosk 10 performs DNA analysis and compares the results to information in local storage 130, a central server 120 or encrypted information stored on a personal information device.
Individual walks up to the Medical Kiosk 10 and places a sensor or detector near the skin where a biometric chip 22 has been implanted. In some cases the biometric chip 22 may be integrated in an article of clothing or as an accessory (e.g. watch or bracelet). The sensor would communicate with the biometric chip 22 through wireless communication means and read information from the chip that could be used to uniquely identify the patient.
   Personal Information Device
Individual walks up to the Medical Kiosk 10 and communication is initiated. A sensor area 56, present on the front of the Medical Kiosk 10, communicates with these personal information devices. While communication may be initiated automatically, patients may also be required to swipe their physical device past this sensor to initiate communication. This communication could be through a wireless protocol (e.g. Bluetooth or RF communication).
Individual walks up and inserts an EPR medical card 30 into a slot 60 on the front of the medical kiosk 10. The kiosk polls the EPR medical card 30 for either identification purposes and/or to retrieve patient information, medical records or the patient care plan.
Individual walks up and inserts a credit card 32 into a slot 60 on the front of the Medical Kiosk 10. The credit card 32 provides the individual's name, address or other identifying information. The Medical Kiosk would search a database (either on a central server 120 or local storage 130) to locate the individual's existing EPR data record 110.

For each of the communication embodiments listed above, a second step may be required to provide unique validation of the individual prior to beginning a session.

Once an individual accesses the Medical Kiosk 10 and verifies their identity, they may manually select a test procedure or the Medical Kiosk 10 may access the individual's patient care plan within their EPR to automatically select the required test(s). Once a test has been identified, the Medical Kiosk 10 will automatically dispense the appropriate custom test equipment via a test dispenser 62. During the test, the individual will be given either verbal feedback on speaker 61 or visual feedback on screen 52 on the progress of the procedure. Item 58 shows a Test in Progress Indicator on the front of the Medical Kiosk 10. When the individual completes a test, they will be able to return all the completed equipment into a receptor 64 on the front of the Medical Kiosk 10. The individual can communicate with third parties through microphone 63.

The Medical Kiosk 10 itself may contain a number of additional features.
A multi-purpose digital camera 50, is used to capture a retinal image/eye scan 20 for individual identification. Additionally this camera could be used to capture real time video to allow the individual to videoconference with a medical professional and/or support person at some remote location.
A display screen 52 presents important instructions, medical information, or test results from the session to the individual. To simplify the user interface, this display could incorporate a touch screen for use in navigating through the testing process. The display screen could also show a live video feed of a physician, medical professional, or support person. Additionally, this display screen 52 could display downloaded images or video from some remote site.
A high-resolution digital camera 54 could be integrated either in a fixed location on the kiosk or on a remote tethered arm to capture digital images for diagnosis purposes. For example, the Medical Kiosk 10 may be used to identify the progress of wound care, analyze moles, or diagnose other skin conditions.
   Creating the EPR Medical Card

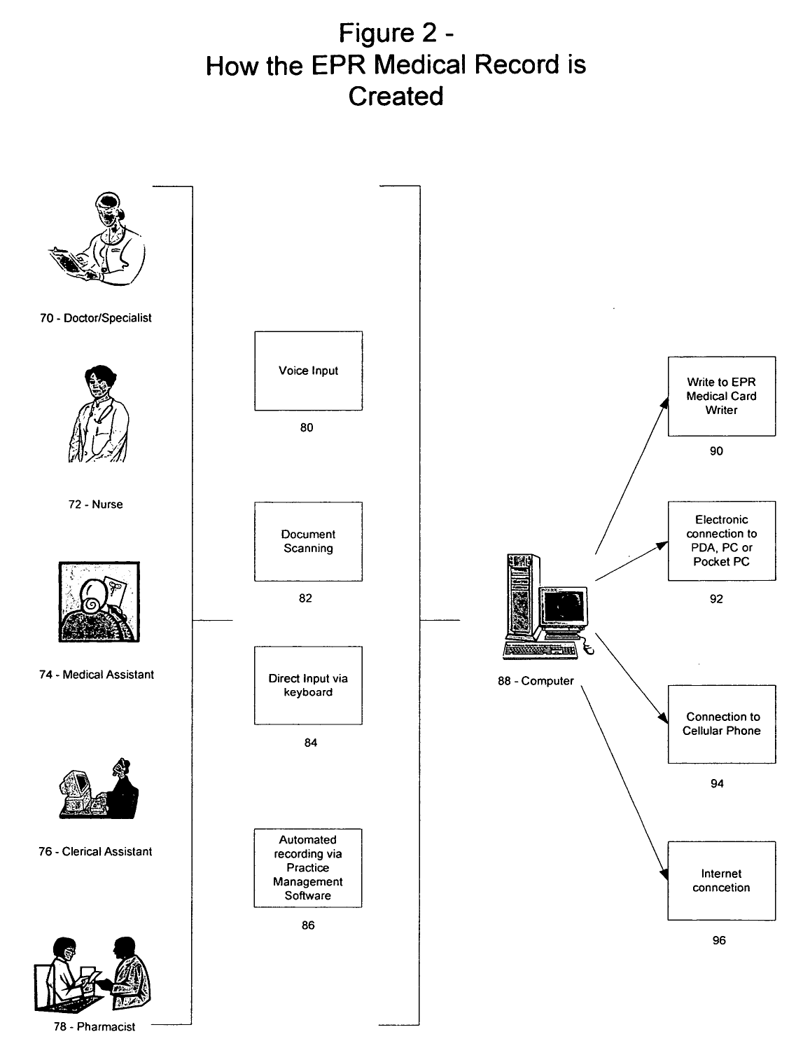

FIG. 2 demonstrates how an EPR Medical Card 30 is created. In general, patient identification and required medical test information are entered into a computer, and this EPR information is then written to a storage. Information may be input by a: doctor/specialist 70, nurse 72, medical assistant 74, clerical assistant 76, or pharmacist 78. This information could be input directly using voice recognition software 80, a computer keyboard 84, or by automated means. For example, medical information could automatically be extracted from existing practice management software 86, or by scanning in existing medical documentation 82. Once information has been input into a computer 88, the data can be transferred to an EPR data record by a number of means including: directly writing to an EPR medical card 90, electronic transfer of information to a PDA, PC or pocket PC 92, transferring to a cell phone 94, or to a remote storage location (i.e. a network central repository central server 120 or kiosk local storage 130) using an Internet connection 96.

Systems Diagram and Potential Data Forms on EPR Embodiments

FIG. 3 illustrates a system diagram for data exchange within a Medical Kiosk environment. The system contains 4 key components:

EPR Data Record 110 Contains:

Patient Information—including the patient's name and address
Patient Verification Information—this information can be a simple password or pin number, or more sophisticated biometric data for identification purposes.
Medical Record—the individual's full medical history, a generic subset of their medical history, and physician comments.
Current Care Plan—The current care plan details a physician's instructions, prescriptions, recommended list of testing procedures and scheduled times. The medical test information can include, but is not limited to, cholesterol, blood glucose, drug detection, Alzheimer's, pregnancy related tests, eye exam, saliva, blood, skin, bodily fluid, body image, electrocardiogram, hyperspectral imaging, multispectral imaging, or oxygenation. Additionally, the current care plan could store information from the insurance company including pre-approval of a testing sequence.
User Preferences—When an individual establishes an account with a Medical Kiosk 10 or a physician, they will create a custom user preferences file. In general these preferences can be classified into five specific categories: personal information, EPR information, physician/insurance company information, access to medical records, and medical records/current care plan.
Personal Information:
   Patient Contact Information—name, address, phone, e-mail
   Emergency contact numbers.
   Preferred prescription fulfillment location.
   Payment method for services rendered at a Medical Kiosk, including insurance authorization, pre-payment plan, credit card or cash payment.
EPR Information:
   Encryption method for securing patient information.
   Preference for where EPR data record 110 is stored (on the Medical Kiosk local storage 130, on a personal information device or on the kiosk's central server 120).
   Preferred method for updating current care plan to reflect results from test procedures.
   Method of preferred digital authorization.
Physician/Insurance Company Information:
   Contact information for all healthcare providers (names, addresses, phone, e-mail).
   Physician preference for reporting of medical information. For example the physician may only want to be notified when there is a problem. In another scenario, the physician may be monitoring the progress of a patient and may request to be notified of all test results.
Permission Levels/Access to Medical Records:
   Permission levels for physicians, insurance companies, and family members to access medical records, current care plan and test results. This includes sharing and notification rights to the tests and/or services being performed at the Medical Kiosk 10. In some cases authorization will be given for all data in the current care plan. In other cases, patients may choose to grant or deny authorization for any specific data.
   Authorizations for “power of doctor.”
   Permission to write to the medical record.
Medical Records/Current Care Plan:
   The patient's current care plan contains records of recent test procedures, doctor's appointments, and medications that are relevant to the patient's current medical issues.
   Schedule of future medical appointments and/or test procedures that need to be performed.
   Patient's long-term medical history. Based on user preferences this could either be a detailed patient history or a high level summary.
      EPR Access

FIG. 3 illustrates an EPR Medical Card 30 as the example, but any of the embodiments can be used. The individual's identity is verified using either a biometric system or a personal information device. Depending upon user preferences and device storage, these embodiments may locally store all the information required for identification and verification of a individual's identity. For embodiments with limited or no storage capabilities, these embodiments will be used to identify the individual, and the Medical Kiosk 10 will verify their identity using additional information stored either on the Medical Kiosk local storage 130 or on the kiosk's central server 120.

For EPR embodiments that contain sufficient memory, patients may choose to store a variety of data elements including either the their full EPR data record 110 or a pointer to the location of the information within the Medical Kiosk environment, such as the kiosk's local storage 130 or central server 120.

Medical Kiosk 10

The Medical Kiosk 10 is designed to be either a networked or a standalone device. Standalone Medical Kiosks will have local storage capabilities. This storage would be utilized to retain critical patient information, medical histories, and user preferences. Networked Medical Kiosks would be able to access a central server 120 across either the Internet or a LAN/WAN 100. Real time patient information and/or test results could be exchanged across this network.

Kiosks Central Server 120

The system may contain a network central repository central server 120 that is utilized for storage and retrieval of the electronic patient records. A central server 120 allows users the flexibility to operate a Medical Kiosk 10 anywhere and at any time to access their EPR. Information stored on this central server 120 can also be exchanged with physicians, insurance companies, caregivers, and key family members. Additionally, the central server 120 would be able to track a patient's progress. For example, the server could track whether or not a patient has filled a prescription and/or missed a scheduled test procedure. In the event that a problem was identified, the kiosk's central server 120 would be able to send emails, phone messages and other alerts to the patient, physician or family members. These messages can include additional tests and the location of the nearest Medical Kiosk.

In most cases the data on the kiosk's central server 120 will be accessed and updated real time over the Internet or LAN/WAN 100. The proposed design also supports exchange of data for situations in which the local Medical Kiosk 10 does not have access to the Internet 100. In this case, the local Medical Kiosk 10 could dial up the central server 120 off hours and exchange patient information.

Functionality of the EPR Medical Card

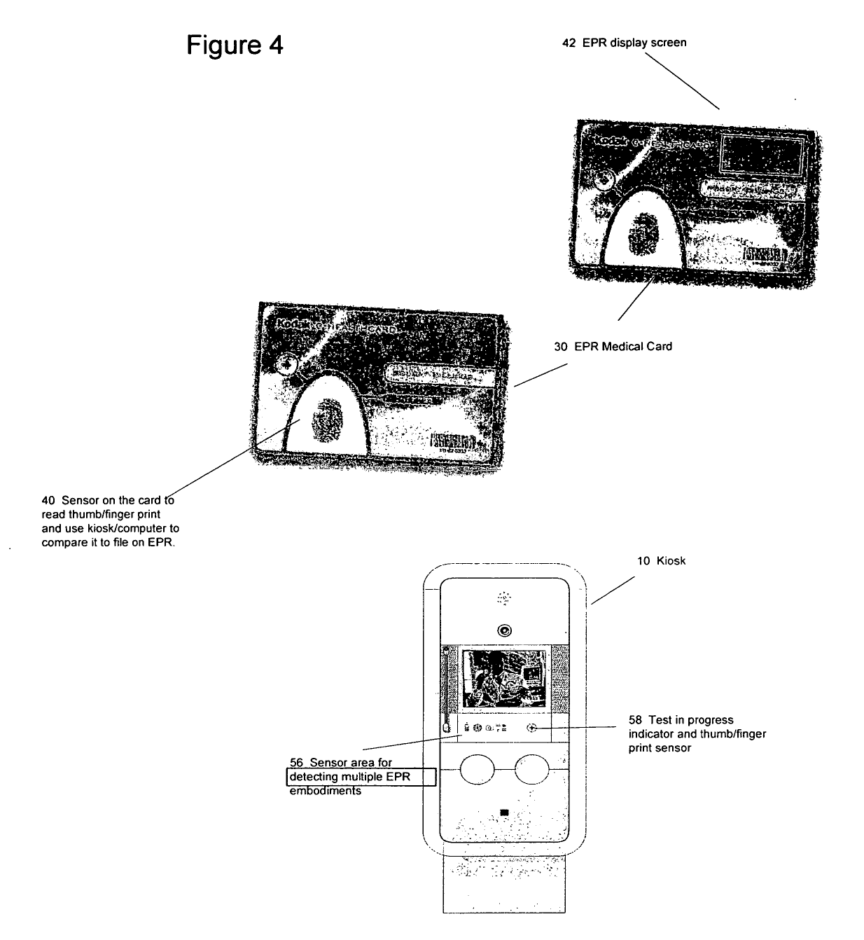

FIG. 4 demonstrates the functionality of the EPR medical card 30. Although the card would appear physically similar to a typical credit card, it would contain a number of unique features. First the card would contain a magnetic strip, RF chip, or memory storage with information to uniquely identify the individual. To access this information the individual would either insert the card in a slot on the Medical Kiosk 10 or swipe the card near a sensor 56 on the system to initiate communication. The Medical Kiosk 10 would read information from the card's magnetic strip, RF chip or memory and attempt to identify the individual. The types of information that could be used as an identifier include a unique patient ID and pin number, or biometric information.

Additionally, in the case of a EPR medical card 30 that contains onboard memory, the card would locally store the individual's EPR. This information is read by the Medical Kiosk 10 and new information from the current testing procedure or physician could be downloaded to the card for long term storage.

Additional features of the EPR Medical Card 30 include;

EPR Display Screen 42—Integration of a small display screen would greatly enhance the capabilities of the card. For example, the EPR display screen 42 may be used to automatically display the date of the next test that is recommended for the patient.
Thumbprint/Fingerprint sensor 40 on the EPR Medical Card—The EPR medical card 30 could incorporate an onboard sensor that would automatically read an individual's fingerprint and compare it to a reference file stored on the card. A thumbprint/fingerprint sensor 58 may also be located on the Medical Kiosk 10 for those devices that do not have such a sensor built into it.
Payment options may also be stored on the EPR medical card 30. For example, individuals may choose to pre-pay for future services. Each time an individual performs a test, the cost of the test would be subtracted from the pre-paid amount. In another scenario an insurance companies could pre-authorize a testing schedule, or finite number of tests. The Medical Kiosk 10 would be able to access this information from either the EPR medical card 30 or the kiosk's central server 120, and automatically track the tests being performed by the patient.
   EPR Card Embodiment at a Medical Kiosk

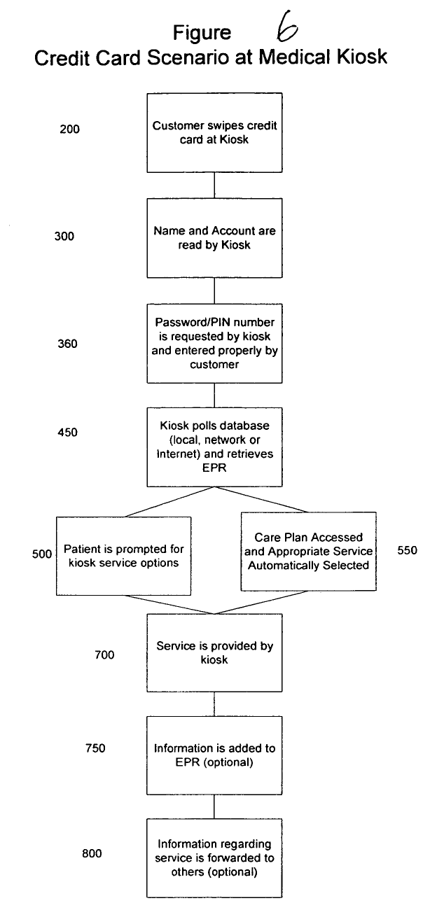

FIG. 6 illustrates a scenario where a patient approaches a Medical Kiosk 10 and swipes their EPR medical card 200 either through a physical card reader 60 or across a smart wireless sensor 56 on the system. The Medical Kiosk 10 will access information on the EPR medical card 220 to identify the user. Once the user is identified the kiosk will access their name, and account information 300. This information may be stored in local storage 130, the central server 120, or the required information could be read directly from the onboard memory on the EPR medical card 30. For security purposes it is necessary to verify the identity of the person entering the kiosk using a second method. Patients may be prompted to enter a unique password/PIN number for a final verification 360. Additionally, biometric information, such as a retinal scan could be used for verification 350.

Once the Medical Kiosk 10 has verified the identity of the patient, the Medical Kiosk 10 will attempt to access the patients medical records and current care plan. In this scenario this information could be retrieved (450) either directly from the memory on the EPR medical card 410, from local storage 130 or from central server 120. If their care plan requires that specific tests be performed, the individual will be informed of the tests that need to be completed 550. Individuals will have the option to select one of these tests, or they can choose to select another service 500. If no care plan exists, patients will have the option to choose what service they would like to perform 500.

When a service is selected, the Medical Kiosk 10 will guide them through the test and provide all the necessary materials, and test results to the patient 700. Once a test is completed a patient will have a number of options:
Choose whether or not the test results are added to their EPR 750. Additionally this information may be stored on local storage 130, the central server 120, or on the EPR medical card 30.
Choose whether or not the test results are accessible to other family members. Additionally they can choose whether the results are submitted to their physician, a specialist, or their insurance company 800.
   NOTE: patients can skip this step if they have previously set up user preferences which detail how, when, and where information will be shared and/or stored for Medical Kiosk test results.
   Credit Card Embodiment at a Medical Kiosk

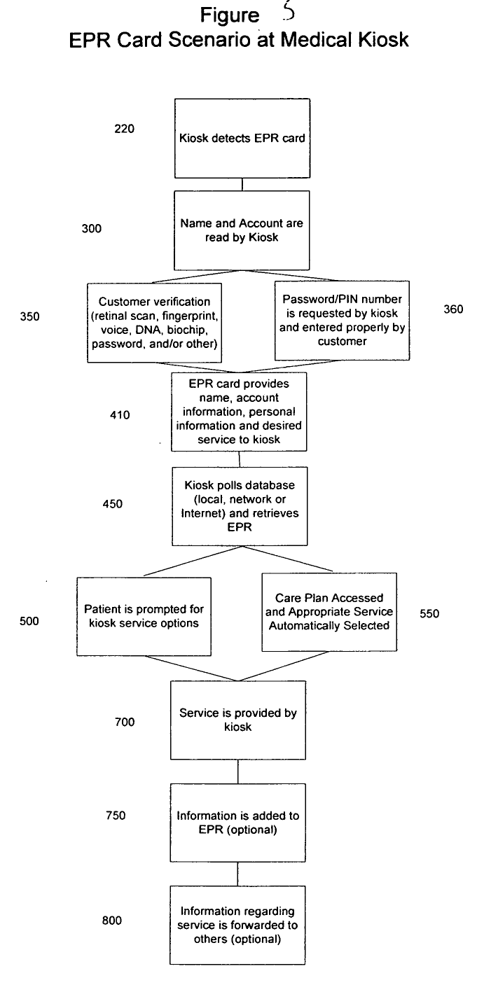

FIG. 5 illustrates a scenario where a patient approaches a Medical Kiosk and swipes any of their credit cards 200. The Medical Kiosk 10 will remotely access their credit card information and identify the user. Once the user is identified the Medical Kiosk 10 will access their name, and account information 300. For security purposes it will be necessary to verify the identity of the person accessing the kiosk using a second method. Patients may be prompted to enter a unique password/PIN number or other identifying information for a final verification 360.

Once the Medical Kiosk 10 has verified the identity of the individual, the Medical Kiosk 10 will access the individual's medical records 450. In this scenario this information will be retrieved either from local storage 130 or from a central server 120. If their care plan requires that specific tests be performed, the patient will be informed of the tests that need to be completed 550. Patients will have the option to select one of these tests, or they can choose to select another service 500. If no care plan exists, patients will have the option to choose what service they would like to perform 500.

When a service is selected, the Medical Kiosk 10 will guide them through the test and provide all the necessary materials, and test results to the patient 700. Once a test is completed a patient will have a number of options:
Choose whether or not the test results are added to their EPR 750.
Choose whether or not the test results are accessible to other family members. Additionally they can choose whether the results are submitted to their physician, a specialist, or their insurance company 800.
   Personal Computer (PC), Personal Digital Assistant (PDA) Pocket PC or Cellular Telephone Embodiment at a Medical Kiosk

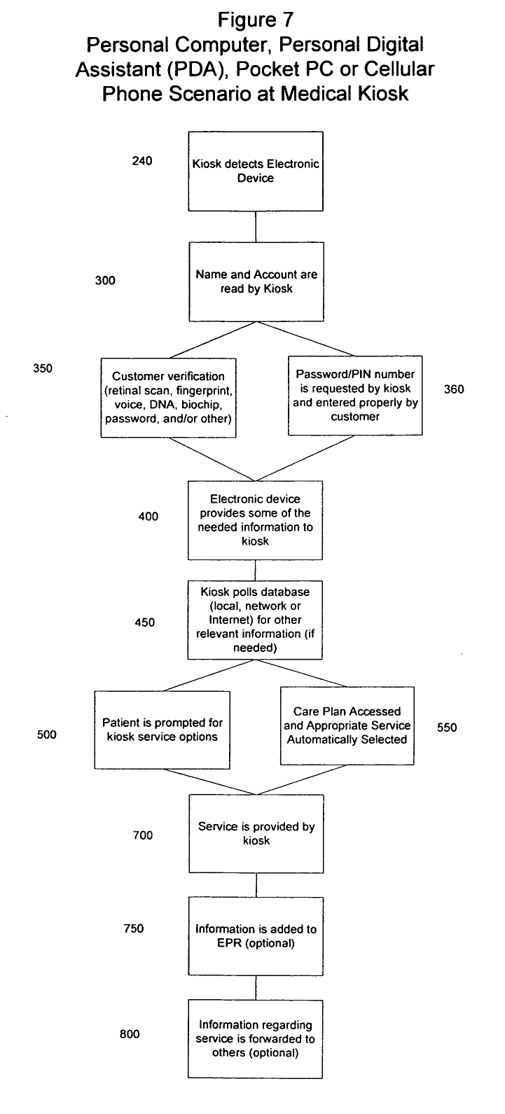

FIG. 7 illustrates a scenario where an individual approaches a Medical Kiosk 10 and swipes their personal computer (PC), personal digital assistant (PDA) 24, pocket PC 26 or cellular telephone 28 across a smart wireless sensor 56 on the system. The Medical Kiosk 10 will attempt to access the devices 240 via a wireless connection (e.g. Bluetooth, RF connection) in an attempt to read information to identify the user. Once the user is identified, the kiosk will access their name, and account information 300. This information may either be stored on local storage 130 or a central server 120, or the required information could be read directly from the onboard memory on these physical devices. For security purposes it is necessary to verify the identity of the person accessing the kiosk using a second method. Individuals may be prompted to enter a unique password/PIN number or other identifying information for a final verification 360. Additionally, biometric information, such as a retinal scan, etc. could be used for verification 350.

Once the kiosk has verified the identity of the individual, the Medical Kiosk 10 will attempt to access the individual's EPR. In this scenario this information could be retrieved 450 either directly from the memory on the physical electronic devices 400, from local storage 130, or from a central server 120. Patient preferences and the specific limitations of these electronic devices (memory, processing power, communication capabilities etc) will determine where the individual's EPR is stored.

If their care plan requires that specific tests be performed, the patient will be informed of the tests that need to be completed 550. Patients will have the option to select one of these tests, or they can choose to select another service 500. If no care plan exists, patients will have the option to choose what service they would like to perform 500.

When a service is selected, the Medical Kiosk 10 will guide them through the test and provide all the necessary materials, and test results to the patient 700. Once a test is completed a patient will have a number of options:
Choose whether or not the test results are added to their EPR 750.
Choose whether or not the test results are accessible to other family members. Additionally they can choose whether the results are submitted to their physician, a specialist, or their insurance company 800.
   NOTE: patients can skip this step if they have previously set up user preferences which detail how, when, and where information will be shared and/or stored for Medical Kiosk test results.

Electronic devices can display information to the patient to remind them of the tests and/or help them locate kiosks where they desire to have the tests performed. It is known that cell phones 28, PDAs 24, and personal computers have the ability to provide directions (Yahoo Map and other web-enabled services). In addition, Global Positioning Systems (GPS) are available on all of these devices that can indicate the current position (or specified locations) and provide information to direct them.

Personal Biometric Sensor or Personal Biometrics Embodiment at a Medical Kiosk

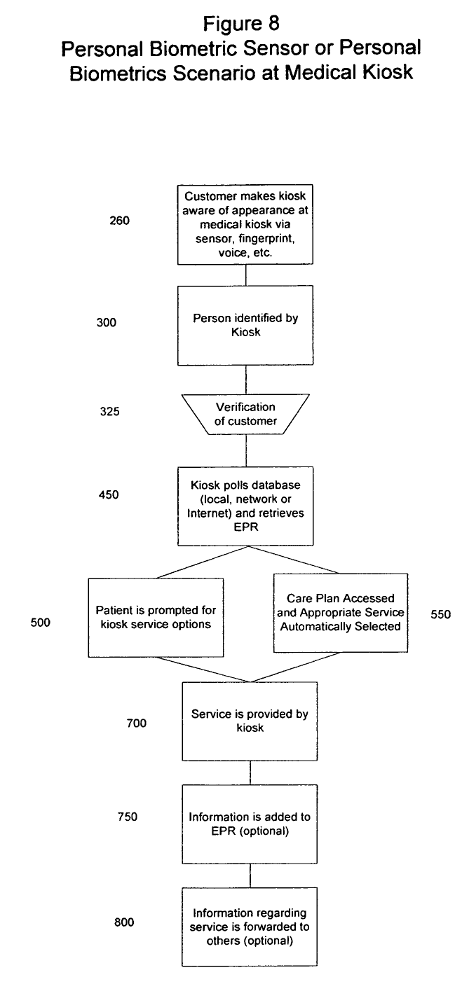

FIG. 8 illustrates a scenario where an individual approaches a Medical Kiosk 10 and pushes a button or is wirelessly identified on the display screen 52 to start a session. The patient instructs the Medical Kiosk 10 to verify their identity 260 using a biometric signature. Possible scenarios include:
Biometric Chip 22—Individual places a sensor or detector near the skin where a biometric chip 22 has been implanted or where the biometric chip 22 is located in an accessory or clothing. The sensor would communicate with the implanted chip through some type of wireless communication (i.e. RF). Information would be read from the chip to uniquely identify the patient. This information is then compared to records in the kiosk's local storage 130 or central server 120.
An individual reads a phrase that is shown on the display screen. Their unique voice print 20b is identified and matched to information in the kiosks central server 120.
Individual provides a hair to identify their unique DNA fingerprint which would be used for identification purposes.
Individual looks into a high-resolution digital camera 50 and the Medical Kiosk 10 captures and analyzes a retinal scan 20a from the patient. The unique retinal signature within the image will be matched against records in the kiosk's central server 120 for patient identification.

Once the user is identified, the Medical Kiosk 10 will access their name, and account information 300, which is stored in local storage 130 or on a central server 120. For security purposes it is necessary to verify the identity of the person accessing the kiosk using a second method if the chip is not embedded or to prevent someone from being coerced to use the system. Patients may be prompted to enter a unique password/PIN number or other identifying information for a final verification 325.

Once the Medical Kiosk 10 has verified the identity of the individual, then it will attempt to access the individual's medical records and current care plan. In this scenario this information will be obtained 450 from local storage 130 or a central server 120.

If their care plan requires that specific tests be performed, the patient will be informed of the tests that need to be completed 550. Patients will have the option to select one of these tests, or they can choose to select another service 500. If no care plan exists, patients will have the option to choose what service they would like to perform 500.

When a service is selected, the Medical Kiosk 10 will guide them through the test and provide all the necessary materials, and test results to the patient 700. Once a test is completed a patient will have a number of options:
Choose whether or not the test results are added to their EPR 750.
Choose whether or not the test results are accessible to other family members. Additionally they can choose whether the results are submitted to their physician, a specialist, or their insurance company 800.
   Medical Kiosk that is not Connected to a Network or the Internet

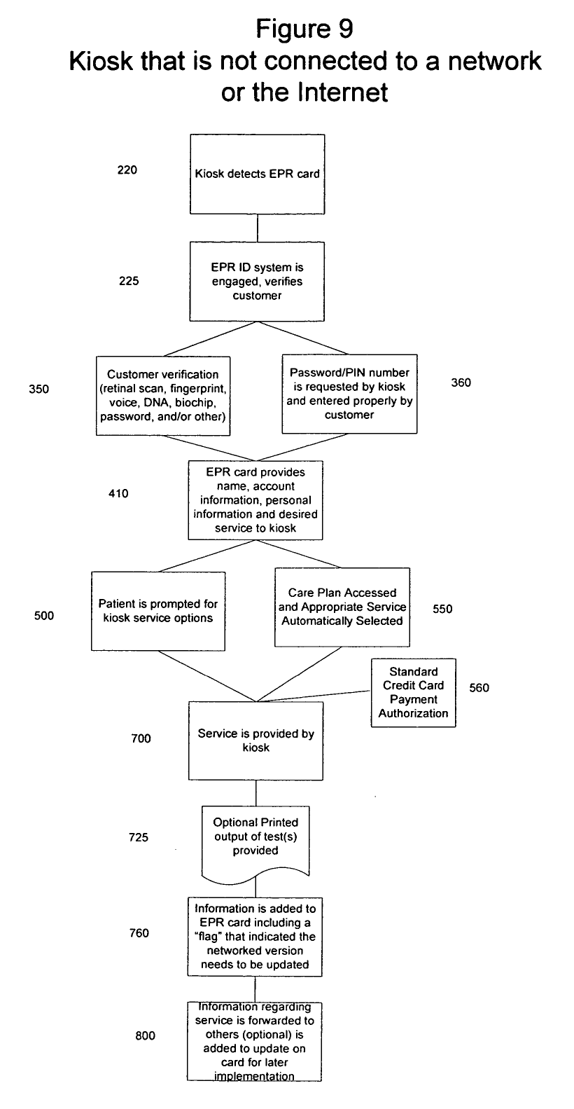

FIG. 9 illustrates a scenario where an individual approaches a Medical Kiosk 10 and swipes their EPR medical card 30 either through a physical card reader 60 or across a smart wireless sensor 58 on the system 220. The Medical Kiosk 10 will access information on the EPR medical card 30 to identify the user 225. Once the user is identified, the Kiosk 10 will access their name and account information. Since the Medical Kiosk 10 is not attached to either the Internet or a network, the kiosk must read this information directly from the onboard memory on the EPR medical card 30. For security purposes it is necessary to verify the identity of the person entering the kiosk using a second method. Patients may be prompted to enter a unique password/PIN number or other identifying information for a final verification 360. Biometric information, such as a retinal scan could also be used for verification 350.

Once the Medical Kiosk 10 has verified the identity of the individual, the system will access the patient's medical records and current care plan from the EPR medical card 410. If specific tests are scheduled to be performed, the patient will be informed of the tests that need to be completed 550. Patients will have the option to select one of these tests, or they can choose to select another service 500. If no care plan exists, patients will have the option to choose what service they would like to perform 500.

Next, the system will query the EPR medical card 30 to determine if the insurance company has pre-authorized any testing procedures and/or determine if pre-paid funds are available. If the selected test procedure is not pre-authorized and/or no pre-paid funds remain on the EPR medical card 30, the Medical Kiosk 10 will contact the credit card company for payment authorization 560.

The Medical Kiosk 10 will guide them through the test and provide all the necessary materials, and test results to the patient 700. Once a test is completed a patient will have a number of options:
Choose whether or not the test results are added to their medical history. Additionally this information may be stored on local storage 130, a central server 120 or on the EPR medical card 30. If the individual requests that information be stored on the central server 120, the information would be transferred and stored at a later time as no network connection exists. The Medical Kiosk 10 would write a “Flag” or indicator on the medical card 30 to indicate that updating of the centralized record needs to be performed once connectivity to the network is available 760. Optionally, a printed output would be needed as evidence of the tests and as the means to communicate the findings to others 725.
Choose whether or not the test results are accessible to other family members. Additionally they can choose whether the results are submitted to either their physician or insurance company 800.
   NOTE: patients can skip this step if they have previously set up user preferences to detail how, when, and where information will be shared/stored for Medical Kiosk test results.

The invention has been described in detail with particular reference to certain preferred embodiments thereof, but it will be understood that variations and modifications can be effected within the scope of the invention.

### PARTS LIST

10 Medical Kiosk

20a retinal scan

20b voice print

20c fingerprint matching

20d DNA analysis

22 biometric chip

24 personal digital assistant (PDA)

26 pocket PC

28 cellular telephone

30 EPR medical card

32 credit card

40 thumb/fingerprint sensor

42 EPR display screen

50 digital camera

52 display screen/interaction area

54 camera for evaluating conditions

56 sensor area

58 Test In Progress Indicator and thumbprint/fingerprint sensor

60 credit card slot

61 speaker

62 test dispenser

63 microphone

64 receptor for completed test

70 doctor/specialist

72 nurse

74 medical assistant

76 clerical assistant

78 pharmacist

80 voice input

82 document scanning

84 direct input via keyboard

86 automated recording via practice management software

88 computer

90 write to EPR medical card writer

92 electronic connection to PCA, PC, or pocket PC

94 connection to cell phone

96 Internet connection

100 Internet or LAN/WAN

110 electronic patient records (EPR)

120 kiosk's central server

130 Local storage of results

200 patient swipes credit card at kiosk

220 kiosk detects EPR medical card

225 EPR ID system is engaged, verifies patient

240 kiosk detects electronic device

260 Patient makes kiosk aware of appearance at Medical Kiosk 10 via sensor, fingerprint, voice, etc.

300 name and account are read by kiosk

325 verification of customer

350 patient verification (retinal scan, fingerprint, voice, PIN, password and/or

360 password/PIN number is requested by kiosk

400 electronic device provides needed information to kiosk

410 EPR medical card provides name, account information, personal information and desired service to kiosk

450 kiosk polls database (local, network or internet) for other relevant information

500 patient is prompted for kiosk service options

550 patient care plan is access and appropriate service automatically selected

560 credit card information accesses for billing

700 service is provided by kiosk

725 optional printed output of test(s)

750 information is added to EPR card including flag

800 information regarding service is forwarded to others—external linkages (doctors, nurses, specialists, pharmacies, caregivers, insurance companies, etc.)

1. A method of entering patient information and required test information on a personal information device comprising:
entering patient identification information into a computer;
entering required medical test information into said computer; and
writing said patient identification information or said required medical test information or both to said personal information device.

2. A method as in claim 1 wherein said personal information device is selected from a group comprising a personal digital assistants (PDA), cell phone, credit card, storage card, medical insurance card, a jump drive, an radio frequency identification (RFID) writable card, or a writable biometric chip.

3. A method as in claim 1 wherein said medical test information is selected from a group comprising cholesterol, blood glucose, drug detection, Alzheimer, or pregnancy related tests.

4. A method as in claim 1 wherein said medical test information is selected from a group comprising eye exam, saliva, blood, skin, body fluid, body image, electrocardiogram, hyper spectral imaging, multispectral imaging, or oxygenation.

5. A method as in claim 1 wherein said patient information or said medical test information or both are transmitted to a storage device.

6. A method as in claim 5 wherein storage device is a network central repository.

7. A method as in claim 1 wherein physician comments are recorded on said personal information device.

8. A method of creating or updating a personal information device comprising:
entering patient identification information on a computer;
entering patient medical history information on said computer;
entering patient current care plan on said computer;
entering patient medical preference information on said computer; and
writing or updating said patient identification information or said patient medical history or said patient current care plan or said patient medical preference information or all of the above on said personal information device.

9. A method as in claim 8 wherein said patient identification information includes security access data.

10. A method of using a Medical Kiosk comprising:
authenticating a personal information device;
verification of an individual using said personal information device;
accessing a medical record on said personal information device;
determining tests to be performed at said Medical Kiosk;
performing said tests; and
recording results of said tests.

11. A method as in claim 10 said authentication consists of said Medical Kiosk communicating with any of multiple embodiments of said personal information device selected from a group comprising a personal digital assistants (PDA), cell phone, credit card, storage card, medical insurance card, a jump drive, an RFID writable card, or a writable biometric chip.

12. A method as in claim 10 said authentication consists of said Medical Kiosk detecting, identifying, and communicating with said personal information device.

13. A method of using a Medical Kiosk comprising:
verifying an identity of an individual using at least one biometric signature;
accessing a medical record for said individual;
determining tests to be performed at said Medical Kiosk;
performing said tests; and
recording results of said tests.

14. A method as in claim 13 wherein said medical records includes payment information.

15. A method according to claim 13 comprising the additional step of:
notifying said individual by means of a personal identification device that a medical test is due, prior to said verifying step.

16. A method according to claim 15 wherein said that notifying step comprises location information for said Medical Kiosk.

17. A Medical Kiosk comprising:
a sensor for authenticating a personal information device;
a microprocessor for verifying a biometric of an individual using said personal information device;
wherein said the microprocessor accesses a medical record on said personal information device;
wherein said microprocessor determines tests to be performed at said Medical Kiosk;
apparatus for performing said tests; and
a recorder for recording results of said tests.

18. A method for using a Medical Kiosk comprising:
swiping a credit card at said Medical Kiosk;
reading an individual's name and account number;
entering a personal identification number (PIN);
accessing a database;
retrieving a patient record for said individual;
selecting kiosk service options; and
providing said selected service.

19. A method as in claim 18 comprising the additional step of:
adding information to said patient record.

20. A method as in claim 18 comprising the additional step of:
forwarding information to a third party.

21. A method as in claim 18 comprising the additional step of:
notifying said individual that a test is required, and a location of a Medical Kiosk prior to said individual swiping said card.

22. A method of using a Medical Kiosk comprising:
detecting an electronic patient record (EPR) card;
verifying an identity of an individual using said EPR card;
retrieving information from said EPR card, said the information selected from a group comprising name, account information, personal information, and desired Medical Kiosk services; and
providing said Medical Kiosk services.

23. A method as in claim 22 wherein said verification comprises a biometric entry or password.

24. A method as in claim 22 comprising the additional step of:
adding information to said patient record.

25. A method as in claim 22 comprising the additional step of:
forwarding information to a third party.

26. A method as in claim 22 comprising the additional step of:
notifying said individual that a test is required and a location of a Medical Kiosk prior to detecting said EPR card.

27. A method as in claim 22 comprising the additional step of:
requesting additional information from a database after information is retrieved from said EPR.

28. A method of using a Medical Kiosk comprising:
entering biometric data into said an equal kiosk;
verifying an identity of an individual entering said biometric data;
verification of intended use by said individual;
retrieving an electronic patient record (EPR) for said individual;
prompting said individual to selected service options; and
providing said selected services.

29. A method as in claim 28 comprising the additional step of:
adding information to said EPR.

30. A method as in claim 28 comprising the additional step of:
forwarding information to a third party.

31. A method as in claim 28 comprising the additional step of:
notifying said individual that a test is required, and a location of a Medical Kiosk prior to entering said biometric data.

32. A method of using a Medical Kiosk comprising:
detecting an electronic patient record (EPR) card;
verifying an identity of an individual using said the PR;
retrieving about said individual from said EPR; and
providing services.

33. A method as in claim 32 comprising the additional step of:
adding information to said EPR.

34. A method as in claim 32 comprising the additional step of:
forwarding information to a third party.

35. A method as in claim 32 comprising the additional step of:
notifying said individual that a test is required, and a location of a Medical Kiosk prior to entering said biometric data.

36. A method as in claim 32 wherein results of services provided are printed.
